(19) United States
(12) Patent Application Publication
(10) Pub. No.: US 2004/0069597 A1
(43) Pub. Date: Apr. 15, 2004

(54) Conveying of articles in the tobacco-processing industry

(75) Inventor: Siegfried Schlisio, Geesthacht (DE)

Correspondence Address: VENABLE, BAETJER, HOWARD AND CIVILETTI, LLP, P.O. BOX 34385, WASHINGTON, DC, 20043-9998, US

(73) Assignee: Hauni Maschinenbau Aktiengesellschaft, Hamburg (DE)

(21) Appl. No.: 10/671,494

(22) Filed: Sep. 29, 2003

(30) Foreign Application Priority Data
Sep. 30, 2002 (DE) 102 45 850.2

(51) Int. Cl. B65G 17/46

(52) U.S. Cl. 198/471.1

(57) ABSTRACT

A method for conveying a rod-shaped article for a tobacco product comprises transferring the rod-shaped article from a first conveying drum to a second conveying drum and supplying a vacuum to the article at the second conveying drum only after the article is transferred to the second conveying drum.

### CROSS-REFERENCE TO RELATED APPLICATION

This application claims the priority of German Patent Application with Serial No. 102 45 850.2, filed on Sep. 30, 2002, the disclosure of which, together with the disclosure of each and every U.S. and foreign patent and patent applications mentioned herein, are incorporated herein by reference.

### BACKGROUND OF THE INVENTION

The invention relates to a method for conveying rod-shaped articles in the tobacco-processing industry, in particular cigarettes, wherein an article is transferred from a first conveying drum to a second conveying drum.

For the purpose of this invention, rod-shaped articles in the tobacco-processing industry are understood to be any objects held in a single-layer row by means of a vacuum on conveyors on, for example, conveying drums for cigarette-production machines, and are transported on these conveyors. Articles of this type are filter cigarettes, cigars, cigarillos, filter rods and the like. The term “cigarettes” is used herein to refer to any of the aforementioned articles.

In a cigarette-production machine, cigarettes are held with the aid of a vacuum in a single-layer row and are transferred on conveying drums crosswise to their axial direction. The conveying drums can be any drums used for processing tobacco including, for example, conveying drums for cigarette-production machines and/or filter-attachment machines. For this, the circumferential surface of the conveying drum is provided with vacuum openings connected to a vacuum source. In transferring cigarettes in a transfer region from a first conveyor to a second, following conveyor, a holding air for the first, releasing conveyor can be interrupted and a holding air for the second, receiving conveyor can be turned on. In order to interrupt the holding air in the circumferential section of the first conveyor that forms the transfer region, fixed control segments are installed on its inside, which cover the vacuum openings of the conveyor in this section, thus cutting off the vacuum.

In the Research Disclosure No. 17011, dated June 1978, an apparatus for carefully separating out rod-shaped articles in the tobacco-processing industry is disclosed. A controllable compressed-air supply is assigned to a conveyor in a transition region, so that an article to be separated out can be transferred via a compressed-air surge from an article-receiving trough in a transporting conveyor to a receptacle in a removing conveyor. The transporting conveyor is provided with a reducing valve for reducing the holding vacuum in the transition region, so that an article such as a cigarette is blown out with compressed air and against the reduced vacuum in the holding bores of a drum of the transporting conveyor.

U.S. Pat. No. 4,452,255, assigned to the assignee of the present application, discloses a transfer of a cigarette from a first drum to a following drum, wherein a holding vacuum applied to the first drum is turned off for the cigarette transfer. If a cigarette is to remain on the first drum because it is defective or as a sample, compressed air is blown from a receiving trough of the following drum to a releasing trough of the first drum, and, thus, reduces a vacuum in the receiving trough of the following drum. At the same time, compressed air from the same compressed-air source is also fed to an injector, which creates a vacuum in the releasing trough of the first drum, so that the cigarette remains in the releasing trough of the first drum during the transfer stage.

European Patent EP 0 584 774 B1 describes a cigarette transfer from a releasing trough of a drum conveyor to a sample-taking drum. For this, the vacuum in a receiving trough of the sample-taking drum is higher than the vacuum in the releasing trough of the drum conveyor.

In conventional drum conveyors, an excessive use of air during the takeover and release of cigarettes can lead to an enormous noise emission and high energy consumption.

### SUMMARY OF THE INVENTION

It is an object of the present invention to reduce the use of air and, at the same time, achieve a reduction in the amount of noise and/or the contamination generated during conveyance of rod-shaped articles in the tobacco-processing industry.

The above and other objects are achieved according to the invention by a method for conveying a rod-shaped article for a tobacco product comprising transferring the rod-shaped article from a first conveying drum to a second conveying drum and supplying vacuum to the article at the second conveying drum only after the article is transferred to the second conveying drum. With the second conveying drum admitting the article with vacuum only after the transfer to the second conveying drum, the invention reduces the overall use of suction air in creating vacuums for the conveying drums and a cigarette producing machine. At the same time, any contamination caused by tobacco crumbs and/or dust particles is also reduced by using less suction air, e.g., by applying the vacuum to the second conveying drum only after the cigarette has been deposited in the trough of the second conveying drum. In addition, the contamination through tobacco crumbs or dust particles is reduced since crumbs and particles are not suctioned in by vacuum bores during the article transfer. The noise emission is furthermore reduced considerably because any “plop” noises during the transfer of the article are eliminated or reduced. With conventional machines, this “plop” noise has so far been generated by the article closing off a suction bore to which a vacuum is fed.

According to a first exemplary embodiment of the invention, a movement of an article during the transfer starts with a movement surge. In a transfer region, an article such as a cigarette can be pushed off the first conveying drum, wherein the movement surge is initiated and triggered by and on the first conveying drum. It is therefore not necessary to have a holding vacuum at the receiving trough of the second, following conveying drum, which is located opposite the releasing trough of the first conveying drum, for the purpose of suctioning the transferred cigarette in. Thus, the movement surge of the cigarette is not caused/generated by the second conveying drum, but only and solely through the first conveying drum. Since a suction vacuum at the second conveying drum can be dispensed with in this case until after the transfer, the use of suction air is reduced. In addition, the noise level can be lowered by having first conveying drum push off the cigarette.

According to a second exemplary embodiment of the invention, blast air can be used to cause the movement surge. A vacuum bore on the first drum, to which a vacuum was fed during the conveying operation, is applied with blast air in the transfer region. As a result, the cigarette is moved toward the second drum with a movement surge. The same vacuum bore in the first drum is applied with a vacuum for conveying cigarettes while in a non-transfer position and with air while in the transfer position. As a result, the design expenditure can be reduced considerably.

According to a third exemplary embodiment of the invention, the transfer movement surge occurs after the article is tensioned. The pre-tensioning can cause the cigarette to move to the receiving trough of the second conveying drum during the transfer. To create the pre-tensioning of the cigarette without bending or curving it, the trough/groove of the first conveying drum can be provided with a trough recess, wherein the cigarette is tensioned by subjecting it to a holding vacuum. By pre-tensioning the cigarette before the transfer, the overall use of vacuum and thus also the noise level can be reduced.

The pre-tensioning of the article can be achieved by applying blast air to parts of the article prior to the transfer, so that the article such as a cigarette can detach itself easier from the receiving trough of the first conveying drum during the transfer. The article is thus transferred carefully, i.e., handled with caution. The use of a vacuum can also be reduced if the vacuum, i.e., the holding vacuum, on the first conveying drum is turned off for the transfer of the article. By using less vacuum, less dust is moved on and in the machine, and, thus, functional improvements such as reduced contamination can be obtained.

According to a fourth exemplary embodiment of the invention, the vacuum applied to the first conveying drum is reduced prior to the transfer. Thus, the use of suction air can be reduced further.

Fresh air can be used as the blast air, wherein the term “fresh air” is understood to mean, for example, cleaned air and/or a vacuum on a cigarette-production machine, or air suctioned in from the environment surrounding the machine. The energy balance is thus improved and any contamination caused by dust particles is simultaneously reduced. According to the invention, the supply of clean fresh air to and into the machine can be targeted and controlled. In addition, the fresh air can also be circulated within a closed circuit for a cigarette-production machine.

By using the present invention, the overall use of air and noise emission of a machine, operated therewith, can be reduced.

### BRIEF DESCRIPTION OF THE DRAWINGS

The foregoing description of the invention will be apparent from the following, more particular description of embodiments of the invention, as illustrated in the accompanying drawings, wherein like reference numbers generally indicate identical, functionally similar, and/or structurally similar elements.

FIG. 1 illustrates a longitudinal section of two conveying drums according to the invention in a transfer region.

FIG. 2 illustrates a cross section of the conveying drums in FIG. 1.

FIG. 3 illustrates a cross section of conventional conveying drums in a transfer region.

FIG. 4 illustrates a cross section of two conveying drums according to the invention in a transfer region.

### DETAILED DESCRIPTION OF THE INVENTION

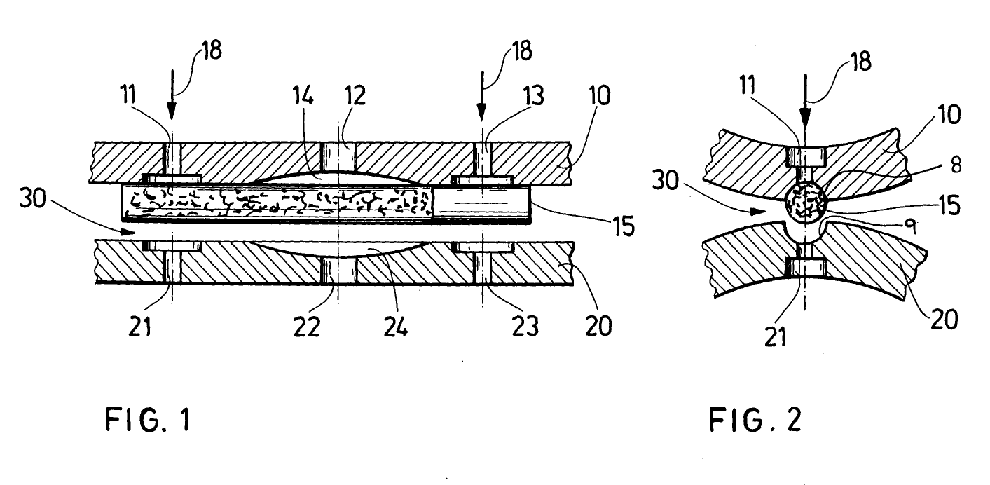

FIG. 1 illustrates a longitudinal section of a conveying drum 10 that releases articles 15 held in respective troughs 8 (see FIG. 2) and of a conveying drum 20 that receives articles 15 in respective troughs 9 in a transition region 30. The conveying drum 10 is provided with blast air bores 11-13 on its circumferential surface. The bores 11 and 13 are blast air bores to which fresh air is supplied. During the transport, a cigarette 15 is held on the conveying drum 10 with the aid of a holding vacuum supplied to a suction/blast bore 12. The suction bore 12 has an enlarged section toward the outside of the conveying drum 10 in the form of a concave recess 14 in troughs. The recess 14 increases the surface for holding the cigarette 15, which surface can be supplied with a vacuum.

The receiving conveying drum 20 is also provided with blast air bores 21-23, which are functionally shaped analogous to the bores 11-13 of conveying drum 10, respectively. Since the two conveying drums 10, 20 can have identical designs, a suction bore 22 also has a longitudinal axial enlargement 24 (e.g., a concave recess) in the respective trough 9 located on the outside of the receiving conveying drum 20.

At the moment of transfer, the blast air bores 11, 13 of the conveying drum 10 are admitted with fresh air 18. Blast air (e.g., fresh air) is also supplied at.-the moment of :transfer and/or in the transfer region 30 to t~he-suction bore 12, so that the cigarette 15 is pushed from the releasing drum 10 to the receiving drum 20. It is not necessary for a vacuum to be present at the bores 21-23 of the conveying drum 20 in order to trigger the movement of cigarette 15.

The movement of cigarette 15 from the releasing drum 10 to the receiving drum 20 can also be triggered in that the cigarette 15 is held in the recess 14 of the trough 8 of the releasing drum 10 with the aid of the vacuum present at the suction bore 12 of the releasing drum 10. When reaching the transfer point, the holding vacuum of the suction bore 12 is turned off and fresh air is supplied to the bore 12. As a result, the pre-tensioned cigarette 15 detaches itself from the trough of the releasing drum 10 and flies from the conveying drum 10 to the conveying drum 20.

FIG. 2 illustrates a cross section of the conveying drums 10, 20 in the transition region 30.

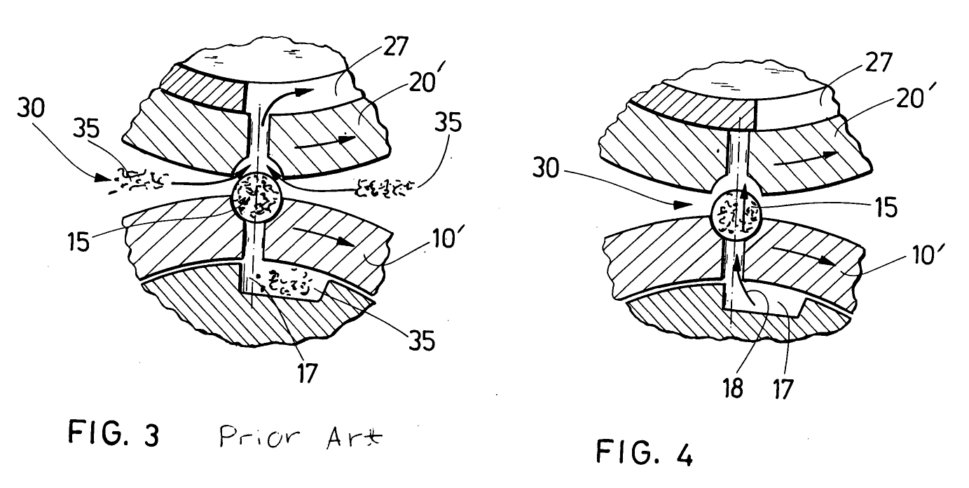

FIG. 3 illustrates a transfer of a cigarette 15 from a conveying drum 10′ to a different conveying drum 20′ according to prior art. In the transfer region 30, a vacuum is supplied to a suction bore of a respective trough in the receiving conveying drum 20′, so that the cigarette 15 is pulled from the receiving trough of the releasing conveying drum 10′ into the receiving trough of the receiving conveying drum 20′. In the transfer region 30, flying dust particles and tobacco crumbs 35 are also suctioned in besides the cigarette 15 by the vacuum present in the channel 27 of receiving conveying drum 20′. Tobacco crumbs 35 additionally also reach channels and intake areas, as shown with channel 17 of conveying drum 10′. The tobacco crumbs 35 lead to a continuous performance reduction in direct relation to the running production time. To compensate for the performance loss, a higher vacuum is generated and supplied to the channel 27. This leads to an increase in the flow-through of air. In addition, the contamination with tobacco crumbs results in higher flow resistances.

FIG. 4 illustrates a cross section of two conveying drums 10′, 20′, according to the invention in the transition region 30. An exhaust channel 17 for the conveying drum 10′ is supplied with fresh air 18, so that the cigarette 15 can be moved from the releasing conveying drum 10′ to the receiving conveying drum 20′. The fresh air 18 furthermore keeps the releasing conveying drum 10′ free of flying tobacco crumbs.

To prevent tobacco crumbs from clogging up the receiving conveying drum 20′, the holding vacuum of the receiving conveying drum 20′ is not supplied via the channel 27 until after the cigarette 15 is held inside the receiving trough of the receiving conveying drum 20′. Thus, while the receiving conveying drum 20′ continues to move, the vacuum is turned on only after the cigarette 15 is transferred to and/or taken over by the conveying drum 20′.

The invention can reduce the required suction air and/or vacuum usage by supplying fresh air in a controlled manner to reduce the contamination of machine parts, particularly conveying drums.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. A method for conveying a rod-shaped article for a tobacco product, comprising:
transferring the rod-shaped article from a first conveying drum to a second conveying drum; and
supplying a vacuum to the article at the second conveying drum only after the article is transferred to the second conveying drum.

2. The method according to claim 1, wherein the step of transferring the article to the second conveying drum comprises moving the article with a movement surge.

3. The method according to claim 2, wherein the step of moving the article with a movement surge comprises triggering the movement surge with blast air.

4. The method according to claim 2, further comprising a step of tensioning the article before the step of moving the article with a movement surge.

5. The method according to claim 4, wherein the step of tensioning the article comprises applying blast air to at least one part of the article prior to the transfer.

6. The method according to one of the claim 1, wherein a vacuum is applied to the article at the first conveying drum, and further comprising a step of turning off the vacuum supplied at the first conveying drum prior to the transfer.

7. The method according to claim 1, wherein a vacuum is applied to the article at the first conveying drum, and further comprising a step of reducing the vacuum supplied to the first conveying drum prior to the transfer.

8. The method according to claim 3, wherein the blast air is fresh air.

9. The method according to claim 1, further comprising a step of tensioning the article before the step of transferring the article.

10. The method according to claim 10, wherein the step of tensioning the article comprises applying blast air to opposite ends of the article.

11. The method according to claim 11, wherein the step of transferring the article comprises triggering a movement surge with blast air applied to a middle region of the article.

12. The method according to claim 11, wherein the step of tensioning the article comprises applying a vacuum to the article through a concave recess of the first conveying drum.
